(19) United States
(12) Patent Application Publication
(10) Pub. No.: US 2008/0172619 A1
(43) Pub. Date: Jul. 17, 2008

(54) GENERATING A SHORT-CUT OF FUNCTIONS FROM PLUGGABLE COMPONENTS

(76) Inventors: Scott R. Carrier, Apex, NC (US); John R. Hind, Raleigh, NC (US)

Correspondence Address: HOFFMAN WARNICK LLC, 75 STATE ST, 14TH FLOOR, ALBANY, NY, 12207, US

(21) Appl. No.: 11/622,144

(22) Filed: Jan. 11, 2007

(51) Int. Cl. G06F 17/00; G06F 9/00

(52) U.S. Cl. 715/739

(57) ABSTRACT

A tool is provided that generates a short-cut of functions from a plurality of pluggable components within an infrastructure container. A historical trail monitoring component is configured to monitor user interactions with the plurality of pluggable components. A pattern detection component is configured to infer a pattern of usage with the plurality of pluggable components from the monitored user interactions. A short-cut generation component is configured to generate the short-cut of functions from the inferred pattern of usage.

### BACKGROUND

This disclosure relates generally to pluggable components within an infrastructure container, and more specifically to generating a short-cut of functions from a plurality of pluggable components within an infrastructure container from a historical trail of user interactions.

One type of infrastructure container that utilizes pluggable components is a portal server. In a portal server environment, a portal manages and displays portlets which are pluggable components. More specifically, each of the user interfaces associated with the portlets can be plugged into other web pages. Portal server applications are often used to improve the efficiency of organizations by providing a single point of interaction with applications, content, business processes, and people. With a single point of interaction with a multiple of applications, a user can perform a business operation by going back and forth from the user interface of one application to the user interface of another application without having to open and close applications. As business operations become more routine, it becomes desirable to streamline repeated interactions that a user has with each of the user interfaces associated with the applications in the portal server environment.

### SUMMARY

In one embodiment, there is a method for generating a short-cut of functions from a plurality of pluggable components within an infrastructure container. In this embodiment, the method comprises: presenting a selectable view containing a sequence of repeated user interactions associated with the plurality of pluggable components; receiving a selection of user interactions from the sequence of repeated user interactions that are indicative of functions that a user desires to have in the short-cut; and generating the short-cut of functions in accordance with the selected user interactions from the sequence of repeated user interactions.

In a second embodiment, there is tool for generating a short-cut of functions from a plurality of pluggable components within an infrastructure container. In this embodiment, the tool comprises a historical trail monitoring component configured to monitor user interactions with the plurality of pluggable components. A pattern detection component is configured to infer a pattern of usage with the plurality of pluggable components from the monitored user interactions. A short-cut generation component is configured to generate the short-cut of functions from the inferred pattern of usage.

In a third embodiment, there is a computer-readable medium storing computer instructions, which when executed, enables a computer system to generate a short-cut of functions from a plurality of pluggable components within an infrastructure container. In this embodiment, the computer instructions comprises presenting a selectable view containing a sequence of repeated user interactions associated with the plurality of pluggable components; receiving a selection of user interactions from the sequence of repeated user interactions that are indicative of functions that a user desires to have in the short-cut; and generating the short-cut of functions in accordance with the selected user interactions from the sequence of repeated user interactions.

In a fourth embodiment, there is a method for generating a virtual form of user interface functions from a plurality of pluggable user interface components within an infrastructure container. In this embodiment, the method comprises: presenting a selectable view containing a primary sequence of repeated user interactions associated with the plurality of pluggable user interface components; receiving a selection of user interactions from the primary sequence of repeated user interactions that are indicative of user interface functions that a user desires to have in the virtual form; presenting a selectable view containing a secondary sequence of repeated user interactions associated with the plurality of pluggable user interface components that have been most often used in conjunction with the selection of user interactions from the primary sequence of repeated user interactions; receiving a selection of user interactions from the secondary sequence of repeated user interactions that are indicative of user interface functions that the user desires to have in the virtual form; presenting a selectable view prompting the user to customize fields associated with the selection of user interactions from the secondary sequence of repeated user interactions; and generating the virtual form of user interface functions in accordance with the selected user interactions from the secondary sequence of repeated user interactions and any customized fields added by the user.

In a fifth embodiment, there is a method for deploying short-cut generation tool for use in a computer system that generates a short-cut of functions from a plurality of pluggable components within an infrastructure container. In this embodiment, a computer infrastructure is provided and is operable to present a selectable view containing a sequence of repeated user interactions associated with the plurality of pluggable components; receive a selection of user interactions from the sequence of repeated user interactions that are indicative of functions that a user desires to have in the short cut; and generate the short-cut of functions in accordance with the selected user interactions from the sequence of repeated user interactions.

Therefore, this disclosure provides a method, tool, and computer-readable medium for generating a short-cut of functions from a plurality of pluggable components within an infrastructure container.

### BRIEF DESCRIPTION OF THE DRAWINGS

FIG. 1 shows a high-level diagram of a short-cut generation tool in use in a portal server environment according to one embodiment of this disclosure;

FIG. 2 is a flowchart describing some of the processing functions associated with using the short-cut generation tool shown in FIG. 1 to infer a pattern of usage with a plurality of pluggable components from a historical trail of user interactions;

FIG. 3 is a flowchart describing some of the processing functions associated with using the short-cut generation tool shown in FIG. 1 to generate a short-cut of functions from a historical trail of user interactions with a plurality of pluggable components;

FIGS. 4a-4d show an example of generating a short-cut of user interface functions with the tool shown in FIG. 1;

FIG. 5 shows a schematic of an exemplary computing environment in which the tool shown in FIG. 1 may operate.

### DETAILED DESCRIPTION

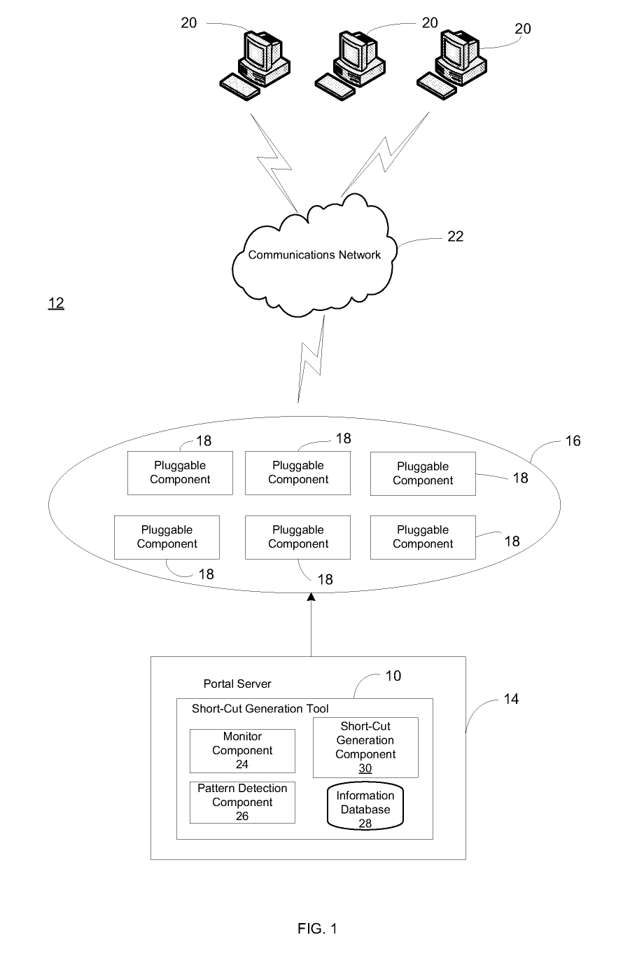

FIG. 1 shows a high-level diagram of a short-cut generation tool 10 in use in a portal server environment 12 according to one embodiment of this disclosure. Although the description that follows is presented in the context of a portal server environment, the short-cut generation tool 10 is suitable for any type of infrastructure container that utilizes pluggable components. Examples of infrastructure containers that utilize pluggable components can include but are not limited to a management console that can plug in control panel applications and the Eclipse framework.

As shown in FIG. 1, the portal server environment 12 comprises a portal server 14 having a portal 16 that displays and manages an aggregation of pluggable components 18 such as portlets. In one embodiment, the pluggable components are pluggable user interface components; however, the disclosure is not limited to pluggable user interface components. Also, the number of pluggable components 18 in FIG. 1 is only for illustration purposes and those skilled in the art will recognize that there may be more or less pluggable components. Users operating computers 20 interact with the pluggable components 18 in the portal 16 through a communication network 22. In one embodiment, a user through computer 20 and communication network 22 accesses a multiple of pluggable components 18 from the portal server 14 that will allow the user to perform a particular task. For example, if the user is a human resources (HR) administrator that is responsible for administrating new employees, then the pluggable components 18 that he or she may open in the portal 16 may relate to items that new employees need such as a mail box, network storage, a blog account, etc. Under this scenario, the HR administrator would to have to run several pluggable components 18 in sequence to set up a mail box, network storage, a blog account and other items for the new employee.

If the HR administrator performs these operations or operations that are similar, every time a new employee joins the company, then the short-cut generation tool 10 on its own or if requested by the HR administrator, can generate a short-cut also referred to herein as a virtual form or a mash-up of functions that the tool believes that the administrator will likely need to complete the operations associated with new employees. A short-cut, virtual form or mash-up of functions that are typically used to administer new employees will obviate the need to run several pluggable components 18 in sequence to set up a mail box, network storage, blog account, etc., every time a new employee begins working at the company.

As shown in FIG. 1, the short-cut generation tool 10 comprises a historical trail monitoring component 24 configured to monitor user interactions with pluggable components 18. A pattern detection component 26 is configured to infer a pattern of usage with the pluggable components 18 from the monitored user interactions. A database 28 is configured to store the pattern of usage inferred by the pattern detection component 26. A short-cut generation component 30 is configured to generate the short-cut of functions from the inferred pattern of usage. Also, the short-cut generation component 30 is configured to present a selectable view containing a sequence of repeated user interactions associated with the pluggable components 18 that are in accordance with the inferred pattern of usage. The short-cut generation component 30 is also configured to receive a selection of user interactions from the sequence of repeated user interactions that are indicative of functions that a user desires to have in the short cut. The short-cut generation component 30 uses the selected user interactions from the sequence of repeated user interactions to generate the short-cut of functions.

In another mode of operation, the short-cut generation tool 10 is configured to generate a short-cut in response to a request made by the user, without any suggestion from the tool itself. In this mode of operation, the user would select the pluggable components 18 that the user wished to incorporate in the short-cut. The user then would select a sequence of repeated user interactions associated with each of the pluggable components 18 that the user wished to incorporate in the short-cut. The short-cut generation component 30 within the tool would then use these selected user interactions and generate the short-cut of functions. An embodiment of this mode of operation is an administration console from which a user may locate the pluggable components through their navigation path or by searching for them through a directory of available applications. After the user selected interactions from the pluggable components that he or she desired to incorporate into the short-cut, the short-cut generation component 30 would then use these interactions to generate the short-cut of functions.

As will become apparent, the capability of the short-cut generation tool 10 to generate short-cuts is not application driven, but instead resides at the infrastructure level. Therefore, as pluggable components are plugged in, the short-cut generation tool 10 can react dynamically and generate short-cuts from historical user interactions regardless of the components because the tool resides at the infrastructure level and as a result can function across applications.

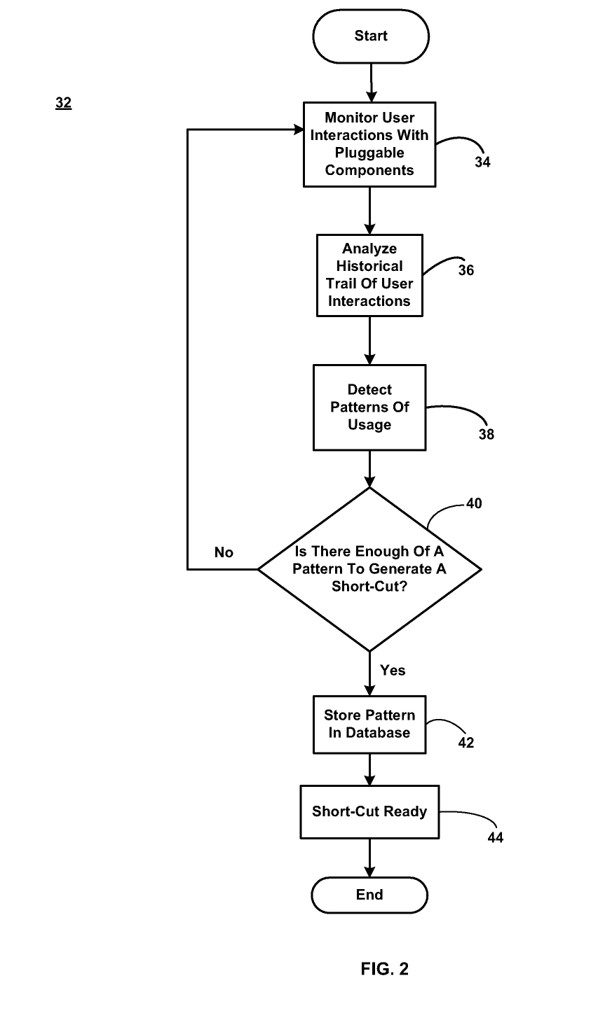

FIG. 2 is a flowchart 32 describing some of the processing functions associated with using the short-cut generation tool 10 shown in FIG. 1 to infer a pattern of usage with the pluggable components 18 from a historical trail of user interactions. The processing functions associated with inferring a pattern of usage from a historical trail of user interactions begin at 34 where the monitoring component 24 monitors a user's interactions with the pluggable components 18. More specifically, the monitoring component 24 tracks where the user started, how the user proceeded and where the user ended his or her session with the pluggable components 18. These sequences of interactions that the user has with the pluggable components 18 results in a trail of user interactions that is known as a breadcrumb trail which is what the monitoring component 24 uses to monitor the paths or actions taken by the user.

While the monitor component 24 is monitoring a user's interactions with the pluggable components 18, the pattern detection component 26 is analyzing the current breadcrumb trail of the user in conjunction with historical trails of sequences or actions previously taken by the user at 36 that are stored in the information database 28. At 38, the pattern detection component 26 is examining the current breadcrumb trail in conjunction with the historical trails in order to detect a pattern of usage. In particular, the pattern detection component 26 is looking for patterns of sequences that the user has previously taken for a given operation. For example, if a user follows a certain four or five paths to perform a specific operation, then the pattern detection component will infer a pattern for that specific operation.

If the pattern detection component 26 determines at 40 that there is not enough information to form a pattern that would warrant suggesting the short-cut, then acts 34-38 are repeated until the pattern detection component 26 can infer a pattern from a user's sequences of interactions with the pluggable components 18. The pattern detection component 26 will be able to typically infer a usage pattern quicker for scenarios where the user repeats the same sequence of actions for a given operation several times in a row as opposed to scenarios where the user takes a few different paths every time to complete the operation. Once the pattern detection component 26 determines at 40 that there is enough information to form a pattern, then it stores the pattern in the information database 28 at 42 and notifies the short-cut generation component 30 at 44 that there is a shortcut.

In one embodiment, the short-cut generation tool 10 will notify the user through a screen view that there is a short-cut that is available that will enable the user to more efficiently perform the operation that he or she is just starting. In another embodiment, the user may invoke the short-cut option by selecting a button that will ask the short-cut generation tool 10 whether a short-cut is possible. For instance, the user after having performing the same set of sequences for a specific operation many times, might want to streamline his or her actions and ask the short-cut generation tool 10 to generate a short-cut.

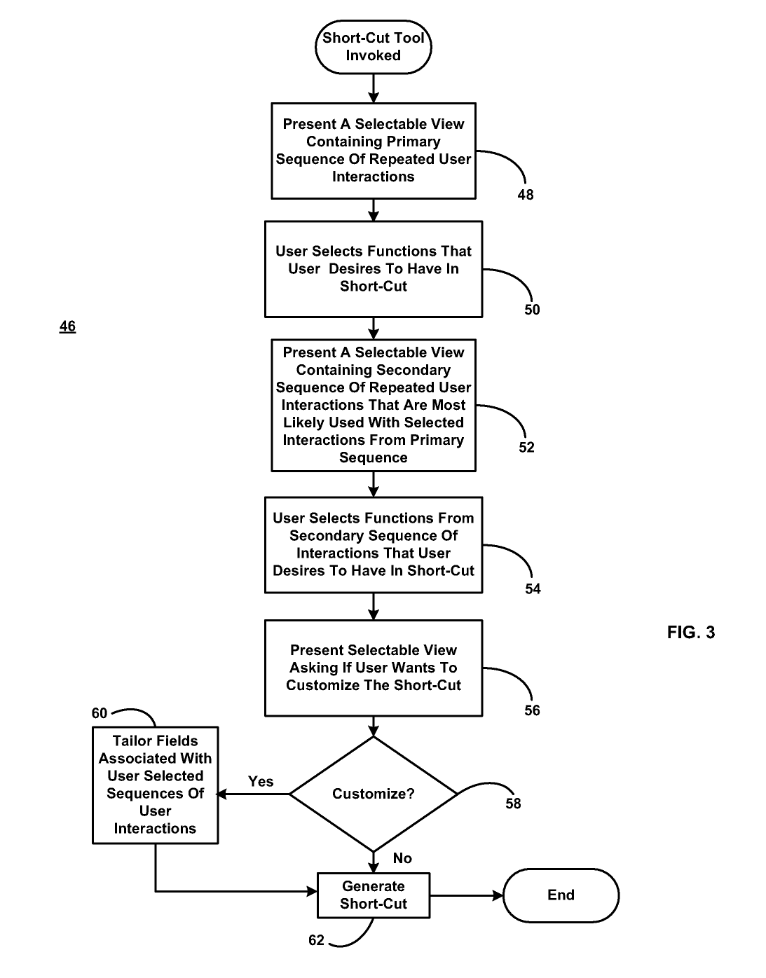

FIG. 3 is a flowchart 46 describing some of the processing functions associated with using the short-cut generation tool 10 shown in FIG. 1 to generate a short-cut of user interface functions once it has been invoked to perform a certain operation. The processing functions associated with generating the short-cut begin at 48, where the short-cut generation tool 10 presents a selectable view to the user that contains a primary sequence of user interactions that the user has repeated to perform the operation. In one embodiment, the primary sequence of user interactions that is presented to the user is sorted and ordered so that the sequence at the top of the view is the one most often used by the user and thus believed to have the highest probability of use, while the sequence at the bottom has the least use and thus the lowest probability of use for this specific operation. Those skilled in the art will recognize that there are a multitude of ways of presenting information to the user and that sorting and ordering by usage is an example and not meant to be limiting.

The user selects the sequence of user interactions from the view of primary sequences at 50 and submits the selection to the short-cut generation tool 10. In response to receiving the user's selection, the short-cut generation tool 10 then presents a selectable view to the user that contains a secondary sequence of user interactions that the user has repeatedly used while performing the selection from the primary sequence at 52. As with the primary sequence of user interactions, the secondary sequence of user interactions in one embodiment is presented to the user according to usage. The user then selects the sequence of user interactions from the view of secondary sequences at 54 that he or she desires to have in the short-cut.

In response to receiving the user's selection, the short-cut generation tool 10 then presents a selectable view to the user that gives the user the option to further customize the short-cut at 56. If the user decides to customize the short-cut as determined at 58, then the user will provide values to tailor the fields associated with the selected sequences of user interactions at 60. In one embodiment, this selectable view will have a listing of fields associated with all of the sequence of users interactions that the user has selected. The user provides input values for these fields, or provides input where to obtain values for the fields. In addition, the user can request that the short-cut generation tool override the fields so that they do not show up in the short-cut. Those skilled in the art will recognize that there are a multitude of ways that the user can tailor the short-cut and that the approach described herein is an example of one embodiment and not limiting of other approaches that can be used. Once the user has decided how to modify the fields, then he or she will submit this information to the short-cut generation tool 10, which will then generate the short-cut at 62. Referring back to decision block 58, if the user does not want to customize the selected sequences of user interactions, then short-cut generation tool 10 will generate the short-cut at 62.

The foregoing flow charts of FIGS. 2 and 3 show some of the processing functions associated with using the short-cut generation tool 10 to generate a short-cut of user interface functions from a historical trail of user interactions. In this regard, each block in the flow charts represents a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe these processing acts may be added.

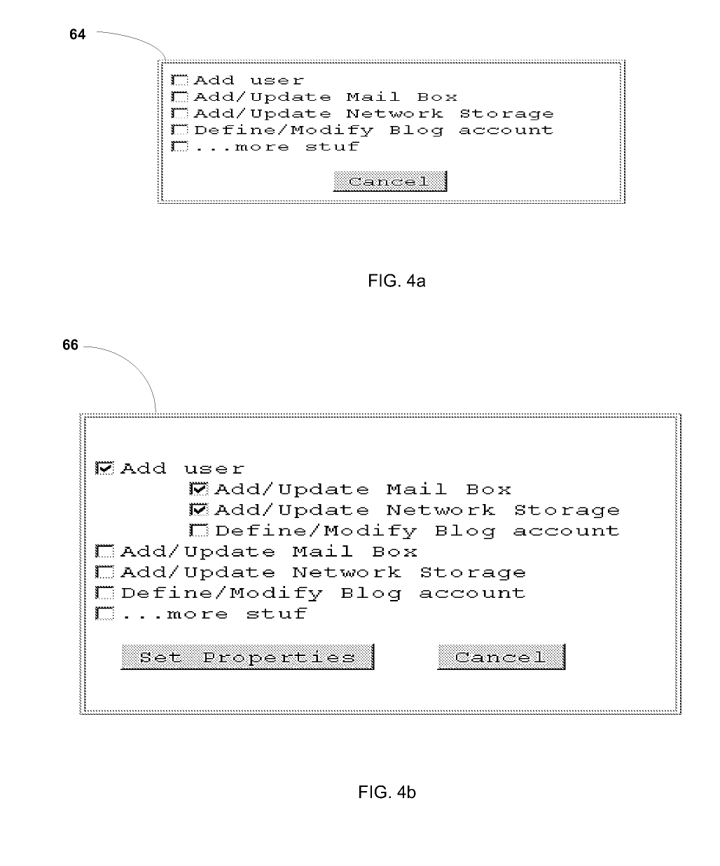

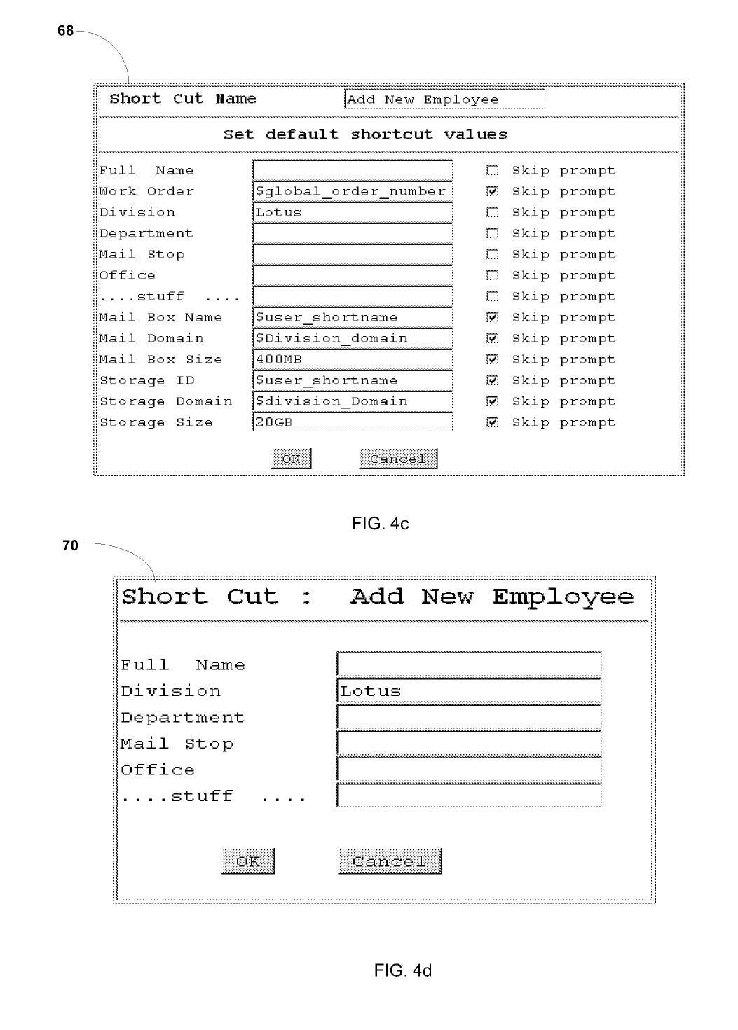

FIGS. 4a-4d show an example of generating a short-cut of user interface functions with the short-cut generation tool 10. In particular, FIGS. 4a-4d show an example of how the short-cut generation tool 10 could be used to generate a short-cut for an HR administrator that is responsible for administrating new employees. In this example, it is assumed that the HR administrator has previously used the pluggable components 18 to perform the operations associated with administrating new employees such that a pattern of usage has been detected by the short-cut generation tool 10. It is also assumed that the next time that the HR administrator uses the pluggable components 18 to administer a new employee will invoke the short-cut generation tool 10, either automatically once the administrator begins performing the functions or by asking the tool 10 to generate a short-cut.

FIG. 4a shows the selectable view 64 that contains a primary sequence of user interactions that the HR administrator has repeated to perform the operations associated with administrating a new employee. In this example, the primary sequence of user interactions that the HR administrator has repeated comprises Add user, Add/Update Mail Box, Add/Update Network Storage, Define/Modify Blog account and . . . more stuff. In FIG. 4a, the primary sequence of user interactions in the selectable view 64 are ordered so that the sequence at the top of the view (i.e., Add user) is the one most often used by the HR administrator and is the sequence that the short-cut generation tool 10 believes has the highest probability of use with the administrator, whereas the sequence at the bottom of the view (i.e., . . . more stuff) is least used by the HR administrator with the Add user sequence and thus believed to have the lowest probability of use with the administrator.

Assuming that in this example that the HR administrator has selected the Add user sequence from the selectable view 64 shown in FIG. 4a, the short-cut generation tool 10 will then present a selectable view to the administrator that contains a secondary sequence of user interactions that the he or she has repeatedly used while performing the Add user sequence. FIG. 4b shows the selectable view 66 that contains a secondary sequence of user interactions that the HR administrator has also performed in conjunction with the Add user sequence. In FIG. 4b, the secondary sequence of user interactions that the HR administrator has performed while adding a user comprises Add/Update Mail Box, Add/Update Network Storage and Define/Modify Blog account. In FIG. 4b, these sequences are ordered underneath the Add user sequence so that the Add/Update Mail Box sequence is the one most often used by the HR administrator with the Add user sequence and the Define/Modify Blog is the sequence that is used least by the HR administrator with the Add user sequence. In FIG. 4b, the HR administrator selects the Add/Update Mail Box and the Add/Update Network Storage as the sequences that he or she would like in the short-cut for the Add user sequence.

In response to receiving the HR administrator's selection, the short-cut generation tool 10 then presents a selectable view to the HR administrator that gives him or her the option to further customize the short-cut. FIG. 4c shows an example of a selectable view 68 that the short-cut generation tool 10 would present to the HR administrator. In FIG. 4c, the selectable view 68 has a listing of fields associated with the sequence of administrator's interactions with the Add user, Add/Update Mail Box and Add/Update Network Storage sequences. Specifically, the selectable view 68, which lists the short-cut name, Add New Employee, at the top of the view, has a listing of the fields on the left-hand side of the view, a section in the middle to enter values for each of the listed fields and a selectable box on the right hand side of the view that gives the administrator the option to skip prompt, or more particularly, to have the short-cut not present these fields in the short-cut.

In FIG. 4c, the HR administrator had decided that he or she wants to see the Full Name, Division, Department, Mail Stop, Office, and . . . stuff fields in the short-cut because the skip prompt box is unselected. Of these fields, the HR administrator has only entered values for the Division field—Lotus, while the value entries for the other fields (i.e., Full Name, Department, Mail Stop, Office, and . . . stuff fields) have been left empty. For the other fields (i.e., Work Order, Mail Box Name, Mail Domain, Mail Box Size, Storage ID, Storage Domain, and Storage Size) in the selectable view 68, the user has either supplied default values for these fields or indicated where the short-cut generation tool 10 can retrieve values to be used with the fields. In particular, the HR administrator has supplied values for the Mail Box Size (400 MB) and the Storage Size (20 GB) fields and indicated where the short-cut generation tool 10 can retrieve values to be used with the Work Order ($global_order_number), Mail Box Name ($user_shortcutname), Mail Domain ($Division_domain), Storage ID ($user_shortname) and Storage Domain ($division_domain) fields. For these fields (i.e., Work Order, Mail Box Name, Mail Domain, Mail Box Size, Storage ID, Storage Domain, and Storage Size), the HR administrator has decided that he or she does not want to see the fields in the short-cut and has selected the skip prompt box. Alternatively, if the HR administrator does not want to tailor the fields he or she has the option to cancel this screen and have these fields presented in the final short-cut.

Continuing with the scenario where the HR administrator did modify the fields in the manner shown in FIG. 4c, the short-cut generation tool 10 receives the administrator's selection and generates the short-cut based on his or her entries to the view 68 shown in FIG. 4c. FIG. 4d shows a view of the short-cut 70 entitled Add New Employee. This short-cut 70 comprises the Full Name, Division, Department, Mail Stop, Office, and . . . stuff fields. All the other fields shown in FIG. 4c were ones that the HR administrator decided that he or she did not want to see and was going to either add default values or indicate where the short-cut generation tool 10 can retrieve values for these fields. With this short-cut, the HR administrator 10 can fill-out one virtual form every time that he or she needs to administer a new employee, obviating the need to sequence through a multiple of pluggable components 18 and repetitively enter data for the new employee because the virtual form is a mash-up of the pluggable user interface components that the administrator would use in administrating the new employee.

In addition to the embodiments described above, there are several functions that the short-cut generation tool 10 can perform. For example, the short-cut generation tool 10 can also be configured to have resulting mash-up short-cuts made publicly available for other users to use. For example, using the HR administrator example, once the HR administrator creates a shortcut for adding a new employee, then he or she can centrally store that short-cut (e.g., in a server) so that other users may either use ‘as-is’ or customize the short-cut to their own needs. A central directory could store these shortcuts and make them available for reuse or customization. Furthermore, access control lists could be introduced to control access, permission, etc. for the various users.

Another function that the short-cut generation tool 10 can perform is to use the short-cuts as building blocks for other short-cuts since they are essentially virtual applications. For example, using the HR administrator example, assume that the HR administrator has created an ‘Add User’ from two to three pluggable component applications. There may be applications/forms that the HR administrator routinely fills out prior to the ‘Add User’ short-cut and perhaps afterwards. In this scenario, the short-cut generation tool 10 can use the ‘Add User’ short-cut as any other application and therefore suggest the creation of a short-cut involving the initial form, the ‘Add User’ form and the one routinely filled out afterwards. In essence, the short-cut generation tool 10 can treat short-cuts as regular applications and incorporate them along with other pluggable component applications in the creation of new short-cuts (i.e. nested short-cuts).

Another function that the short-cut generation tool 10 can includes executing the underlying operations associated with each of the short-cuts synchronously where appropriate. For example, using the HR administrator example, if there is an ‘Add User’ short-cut comprising forms A, B, and C where form B is dependent on the execution return value of form A. In this scenario, forms A+C can be executed synchronously, while form B waits for the return of A and is therefore executed serially.

In addition to having underlying forms that are not dependent on other forms execute synchronously, while dependent forms execute serially, the short-cut generation tool 10 can retain this order of execution when short-cuts are nested regardless of how many layers of nesting exist. This simplifies access to application user interfaces based on a user's usage of the tool and maximizes the speed of execution (i.e. users can only process applications serially, whereas when applications are rolled-up into short-cuts, the short-cut generation tool 10 can execute portions of those applications synchronously).

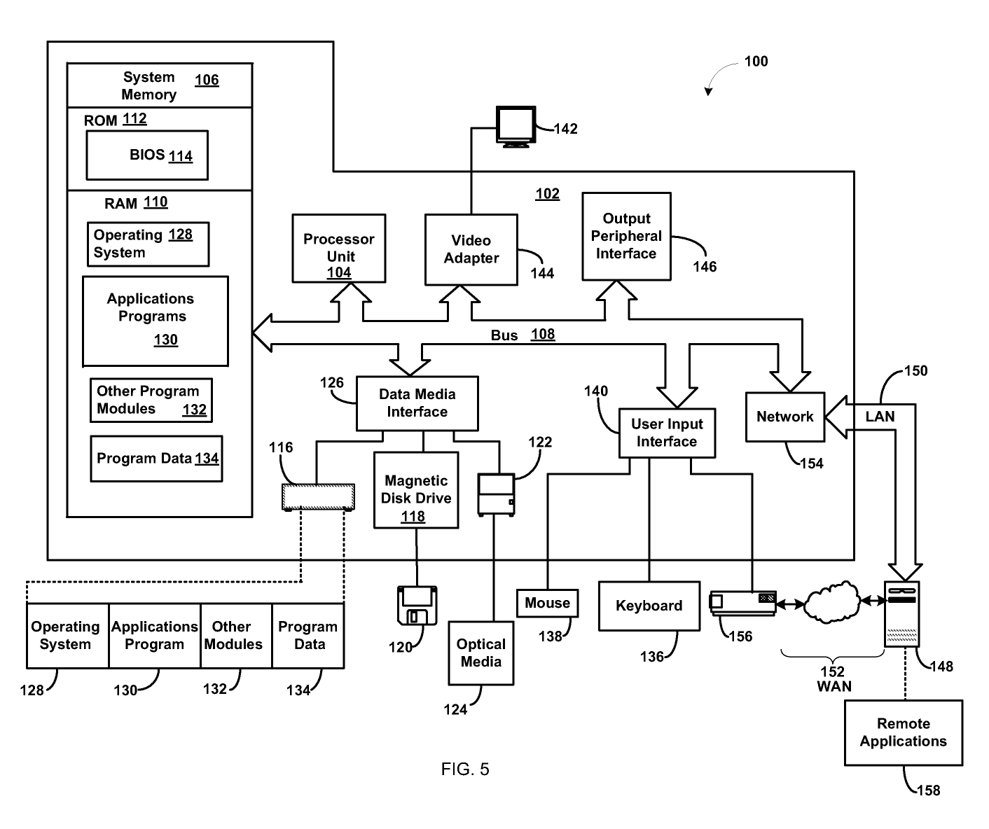

FIG. 5 shows a schematic of an exemplary computing environment 100 in which the short-cut generation tool 10 shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 5.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 5, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 5, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 5 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134.

Each of the operating system 128, one or more application programs 130 other program modules 132, and program data 134 or some combination thereof, may include an implementation of the short-cut generation tool 10 of FIG. 1 which generates a short-cut of functions from a plurality of pluggable components within an infrastructure container. Specifically, each may include an implementation of the short-cut generation tool 10 which presents a selectable view containing a sequence of repeated user interactions associated with the plurality of pluggable components; receives a selection of user interactions from the sequence of repeated user interactions that are indicative of functions that a user desires to have in a short cut; and generates the short-cut of functions in accordance with the selected user interactions from the sequence of repeated user interactions.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 5 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 5 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this disclosure, an approach for generating a short-cut of functions from pluggable components. While the disclosure has been particularly shown and described in conjunction with a preferred embodiment thereof, it will be appreciated that variations and modifications can be effected by a person of ordinary skill in the art without departing from the scope of the disclosure.

In another embodiment, this disclosure provides a business method that performs the process steps of the disclosure on a subscription, advertising, and/or fee basis. That is, a service provider could offer to generate a short-cut of functions from a plurality of pluggable components within an infrastructure container. In this case, the service provider can create, deploy, maintain, support, etc., a short-cut generation tool, such as tool 10 (FIG. 1) that performs the processes described in the disclosure for one or more customers. In return, the service provider can receive payment from the customer(s) under a subscription and/or fee agreement and/or the service provider can receive payment from the sale of advertising content to one or more third parties.

In still another embodiment, this disclosure provides a method for using a short-cut generation tool within a computer system to generate a short-cut of functions from a plurality of pluggable components within an infrastructure container. In this case, a short-cut generation tool, such as tool 10 (FIG. 1), can be provided and one or more systems for performing the processes described in the disclosure can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the disclosure.

What is claimed is:

1. A method for generating a short-cut of functions from a plurality of pluggable components within an infrastructure container, comprising:
presenting a selectable view containing a sequence of repeated user interactions associated with the plurality of pluggable components;
receiving a selection of user interactions from the sequence of repeated user interactions that are indicative of functions that a user desires to have in the short-cut; and
generating the short-cut of functions in accordance with the selected user interactions from the sequence of repeated user interactions.

2. The method according to claim 1, wherein the presenting of a selectable view containing a sequence of repeated user interactions comprises presenting a primary sequence of repeated user interactions with the plurality of pluggable components.

3. The method according to claim 2, wherein the primary sequence of repeated user interactions are representative of a pattern of interactions that the user is most likely to have with the plurality of pluggable components.

4. The method according to claim 2, wherein the presenting of a selectable view containing a primary sequence of repeated user interactions comprises listing the sequence of repeated user interactions in an order that the user is most likely to interact with the plurality of pluggable components.

5. The method according to claim 2, further comprising presenting a selectable view containing a secondary sequence of repeated user interactions associated with the plurality of pluggable components in response to a selection of user interactions in the primary sequence of repeated user interactions, wherein the secondary sequence of repeated user interactions have been most often used in conjunction with the selection of user interactions from the primary sequence.

6. The method according to claim 5, further comprising presenting a selectable view in response to a selection of user interactions in the secondary sequence of repeated user interactions that prompts the user to customize a list of fields associated with the selection of interactions from the secondary sequence.

7. The method according to claim 6, wherein the generating of the short-cut of functions comprises generating a virtual form based on the selected user interactions from the secondary sequence of repeated user interactions and any customized fields added by the user.

8. The method according to claim 1, further comprising inferring the sequence of repeated user interactions with the plurality of pluggable components from a historical trail of user interactions that are indicative of a pattern of usage with the components.

9. A tool for generating a short-cut of functions from a plurality of pluggable components within an infrastructure container, comprising:
a historical trail monitoring component configured to monitor user interactions with the plurality of pluggable components;
a pattern detection component configured to infer a pattern of usage with the plurality of pluggable components from the monitored user interactions; and
a short-cut generation component configured to generate the short-cut of functions from the inferred pattern of usage.

10. The tool according to claim 9, further comprising a database configured to store the pattern of usage inferred by the pattern detection component.

11. The tool according to claim 9, wherein the short-cut generation component is configured to present a selectable view containing a sequence of repeated user interactions associated with the plurality of pluggable components that are in accordance with the inferred pattern of usage.

12. The tool according to claim 11, wherein the short-cut generation component is configured to receive a selection of user interactions from the sequence of repeated user interactions that are indicative of functions that a user desires to have in the short cut.

13. The tool according to claim 12, wherein the short-cut generation component is configured to generate the short-cut of functions in accordance with the selected user interactions from the sequence of repeated user interactions.

14. A computer-readable medium storing computer instructions, which when executed, enables a computer system to generate a short-cut of user interface functions from a plurality of pluggable components within an infrastructure container, the computer instructions comprising:
presenting a selectable view containing a sequence of repeated user interactions associated with the plurality of pluggable components;
receiving a selection of user interactions from the sequence of repeated user interactions that are indicative of functions that a user desires to have in the short-cut; and
generating the short-cut of functions in accordance with the selected user interactions from the sequence of repeated user interactions.

15. The computer-readable medium according to claim 14, wherein the presenting of a selectable view containing a sequence of repeated user interactions comprises instructions for presenting a primary sequence of repeated user interactions with the plurality of pluggable components.

16. The computer-readable medium according to claim 15, further comprising instructions for presenting a selectable view containing a secondary sequence of repeated user interactions associated with the plurality of pluggable components in response to a selection of user interactions in the primary sequence of repeated user interactions, wherein the secondary sequence of repeated user interactions have been most often used in conjunction with the selection of user interactions from the primary sequence.

17. The computer-readable medium according to claim 16, further comprising instructions for presenting a selectable view in response to a selection of user interactions in the secondary sequence of repeated user interactions that prompts the user to customize a list of fields associated with the selection of interactions from the secondary sequence.

18. The computer-readable medium according to claim 17, wherein the generating of the short-cut of functions comprises instructions for generating a virtual form based on the selected user interactions from the secondary sequence of repeated user interactions and any customized fields added by the user.

19. The computer-readable medium according to claim 16, wherein the presenting of a selectable view containing a primary sequence and secondary sequence of repeated user interactions comprises instructions for listing the sequences of repeated user interactions in an order that the user is most likely to interact with the plurality of pluggable components.

20. A method for generating a virtual form of user interface functions from a plurality of pluggable user interface components within an infrastructure container, comprising:
presenting a selectable view containing a primary sequence of repeated user interactions associated with the plurality of pluggable user interface components;
receiving a selection of user interactions from the primary sequence of repeated user interactions that are indicative of user interface functions that a user desires to have in the virtual form;
presenting a selectable view containing a secondary sequence of repeated user interactions associated with the plurality of pluggable user interface components that have been most often used in conjunction with the selection of user interactions from the primary sequence of repeated user interactions;
receiving a selection of user interactions from the secondary sequence of repeated user interactions that are indicative of user interface functions that the user desires to have in the virtual form;
presenting a selectable view prompting the user to customize fields associated with the selection of user interactions from the secondary sequence of repeated user interactions; and
generating the virtual form of user interface functions in accordance with the selected user interactions from the secondary sequence of repeated user interactions and any customized fields added by the user.
